(19) United States
(12) Patent Application Publication
(10) Pub. No.: US 2018/0131798 A1
(43) Pub. Date: May 10, 2018

(54) Method of installing a wireless earpiece within an ear and providing instructions regarding same

(71) Applicant: BRAGI GmbH, Munchen (DE)

(72) Inventor: Nikolaj Hviid, Munchen (DE)

(73) Assignee: BRAGI GmbH, Munchen (DE)

(21) Appl. No.: 15/806,059

(22) Filed: Nov. 7, 2017

Related U.S. Application Data
(60) Provisional application No. 62/418,481, filed on Nov. 7, 2016.

(51) Int. Cl. H04M 1/60; H04R 1/10

(52) U.S. Cl. CPC H04M 1/6066; G10K 2210/1081; H04R 2420/07; H04R 1/10

(57) ABSTRACT

A method of installing a wireless earpiece into an ear canal of an ear includes providing the wireless earpiece having a center of mass and a speaker tip, positioning the speaker tip proximate to the ear, toward the ear canal and below the center of mass of the wireless earpiece, inserting the speaker tip into the ear canal, and rotating the wireless earpiece backward until the wireless earpiece is substantially secure in the ear. A method of instructing a user as to how to place a wireless earpiece into an ear using a software application includes providing a computing device having a screen display element, locating the software application using the computing device, executing the software application using the computing device and communicating the instructions and animations related to placing the earpiece into the ear on the screen display element.

### PRIORITY STATEMENT

This application claims priority to U.S. Provisional Patent Application No. 62/418,481 filed on Nov. 7, 2016 titled Method of installing a wireless earpiece within an ear and providing instructions regarding same all of which is hereby incorporated by reference in its entirety.

### FIELD OF THE INVENTION

The present invention relates to wearable devices. More particularly, but not exclusively, the present invention relates to wireless earpieces.

### BACKGROUND

Electronic earpieces are a new concept in consumer electronics. Since the concept is new, it is not well understood how to properly place an earpiece into an ear. Proper placement enhances the enjoyment of the device. What is needed is a method which provides the user instructions as to the proper “installation” of the earpiece into their ear or ears.

### SUMMARY

Therefore, it is a primary object, feature, or advantage of the illustrative embodiments to improve over the state of the art.

It is a further object, feature, or advantage of the illustrative embodiments to provide visual instruction on how to place a wireless earpiece into an ear.

It is a still further object, feature, or advantage of the illustrative embodiments to provide visual instruction on how to place a wireless earpiece into an ear using a software application.

Another object, feature, or advantage is to provide visual instruction on how to optimally position a wireless earpiece into an ear using a software application.

Yet another object, feature, or advantage is to provide animations with the visual instructions using a software application.

Yet another object, feature, or advantage is to provide visual instruction on how to place a left wireless earpiece and a right wireless earpiece.

In one embodiment, a method of installing a wireless earpiece into an ear canal of an ear includes providing the wireless earpiece having a center of mass and comprising a speaker tip, positioning the speaker tip proximate to the ear, toward the ear canal and below the center of mass of the wireless earpiece, inserting the speaker tip into the ear canal, and rotating the wireless earpiece backward until the wireless earpiece is substantially secure in the ear.

One or more of the following features may be included. One or more wireless earpieces may comprise a left wireless earpiece and a right wireless earpiece. The ear canal of the ear may comprise a left wireless earpiece and a right wireless earpiece. The wireless earpiece may be further fitted by opening the user's mouth. Each wireless earpiece may be further positioned in each ear canal to substantially enclose each outer opening.

In another embodiment, a method of instructing a user as to how to place a wireless earpiece into an ear using a software application includes providing a computing device having a screen display element, locating the software application using the computing device, wherein the software application comprises instructions and animations related to placing the wireless earpiece into the ear, executing the software application using the computing device, and communicating the instructions and animations related to placing the wireless earpiece into the ear on the screen display element.

One or more of the following may be included. The wireless earpiece may be placed into the ear. The placement of the wireless earpiece may be performed by the user. The wireless earpiece may comprise a left wireless earpiece and a right wireless earpiece. The instructions and animations related to placing the wireless earpiece into the ear may further comprise instructions and animations related to placing the left wireless earpiece into a left ear and placing the right wireless earpiece into a right ear. The computing device may further comprise a first user interface. The locating of the software application may be performed using the first user interface. The software application may comprise a second user interface. The instructions and animations related to placing the wireless earpiece into the ear may be formatted into a plurality of interactive screens. The first user interface may be used to scroll through the plurality of interactive screens. The second user interface may be used to scroll through the plurality of interactive screens. The second user interface may be used to interact with the plurality of interactive screens. The computing device may be a mobile device having a screen display. The software application may be a mobile app.

One or more of these and/or other objects, features, or advantages of the illustrative embodiments will become apparent from the specification and claims that follow. No single embodiment need provide each and every object, feature, or advantage. Different embodiments may have different objects, features, or advantages. Therefore, the illustrative embodiments are not to be limited to or by an object, feature, or advantage stated herein.

### BRIEF DESCRIPTION OF THE DRAWINGS

FIG. 1 illustrates a system including a set of wireless earpieces and a mobile device.

FIG. 2 illustrates a set of wireless earpieces in additional detail.

FIG. 3 is a block diagram illustrating a wireless earpiece.

FIG. 4 illustrates one example of a screen display associated with a left wireless earpiece.

FIG. 5 illustrates one example of a screen display associated with a right wireless earpiece.

FIG. 6 illustrates another example of a screen display showing charge levels of both a left wireless earpiece and a right wireless earpiece and an activity menu with various items.

FIG. 7 illustrates an example of a display showing monitoring information associated with a selected activity.

FIG. 8 illustrates an example of a display showing profile information for an individual or user.

FIG. 9 illustrates an example of a display showing service information.

FIG. 10 illustrates an example of a display showing a user manual.

FIG. 11 illustrates an example of a display showing tutorial videos.

FIG. 12 illustrates an example of a display showing more tutorial videos.

FIG. 13 illustrates an example of a display showing more tutorial videos.

FIG. 14 illustrates a video concerning placing the wireless earpiece into an ear.

FIG. 15 illustrates one embodiment of a method of installing a wireless earpiece into an ear canal of an ear.

FIG. 16 illustrates one embodiment of a method of instructing a user as to how to place a wireless earpiece into an ear using a software application.

FIG. 17 depicts a computing system 1700 in accordance with an illustrative embodiment.

Various of the figures include ornamental appearance for various elements. It is to be understood that the present invention contemplates all permutations and combinations of the various graphical elements set forth in the displays and any portions thereof.

### DETAILED DESCRIPTION

FIG. 1 illustrates wireless earpieces 10 including a left earpiece 12A and a right earpiece 12B. One or more of the left wireless earpiece 12A and the right wireless earpiece 12B are in operative communication with a mobile device 4 which includes a display 6. The display 6 may be a touch-sensitive screen or other form of display or interface for receiving user interaction, feedback, and input through the mobile device 4 from one or more users.

The wireless earpieces 10 are shaped and configured to fit in ears of a user. The wireless earpieces 10 may be utilized to play music, perform communications, play media, measure user biometric input and environmental conditions, and any number of other functions. The wireless earpieces 10 may include any number of internal and external sensors for measuring biometrics, environmental conditions, and other input relevant to the user and their operation.

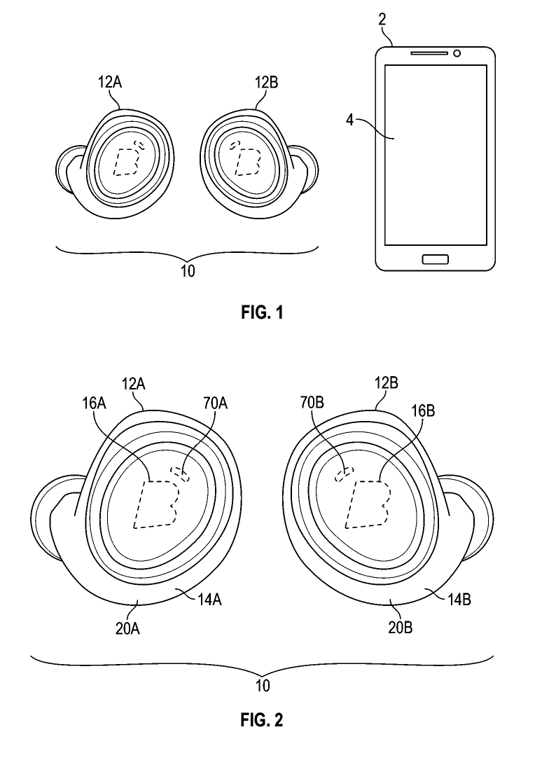

FIG. 2 illustrates in additional detail the set of wireless earpieces 10 of FIG. 1 in which includes the left wireless earpiece 12A and the right wireless earpiece 12B. Each of the wireless earpieces 12A, 12B has an earpiece housing 14A, 14B which may be in the form of a protective shell or casing and may be an in-the-ear housing. A left infrared through ultraviolet spectrometer 16A and right infrared through ultraviolet spectrometer 16B are also shown. Each wireless earpiece 12A, 12B may include one or more microphones 70A, 70B. Note that the air microphones 70A, 70B are outward facing such that the air microphones 70A, 70B may capture ambient environmental sound and audio. It is to be understood that any number of microphones may be present including air conduction microphones, bone conduction microphones, or other audio sensors. An ear-bone microphone may sit against the skin, tissue, and bones of the user.

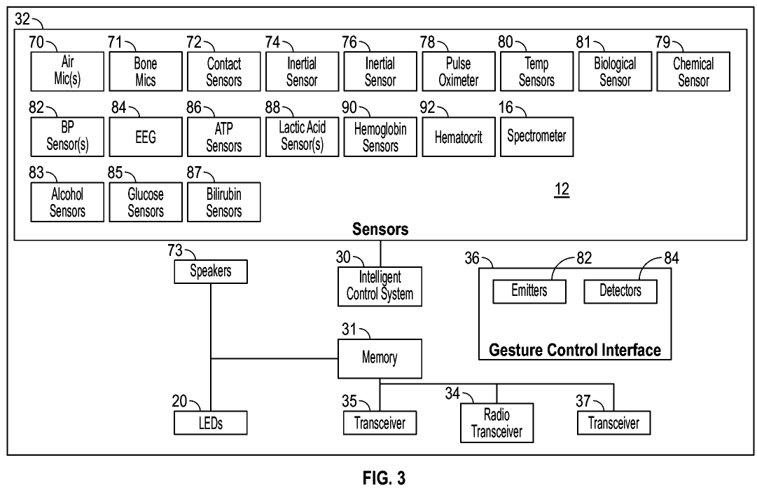

FIG. 3 is a block diagram illustrating a wireless earpiece 12, such as the left wireless earpiece 12A or the right wireless earpiece 12B of FIGS. 1-3. The wireless earpiece 12 may include one or more LEDs 20 electrically connected to an intelligent control system 30. The intelligent control system 30 may include one or more processors, microcontrollers, application specific integrated circuits, or other types of integrated circuits. The intelligent control system 30 may also be electrically connected to one or more sensors 32. The sensors may include inertial sensors 74, 76. Each inertial sensor 74, 76 may include an accelerometer, a gyroscope, gyro sensor, or gyrometer, a magnetometer, and/or other type of inertial sensors.

The sensors 32 may also include one or more of contact sensors 72, bone conduction microphones 71, air conduction microphones 70, chemical sensors 79, a pulse oximeter 76, one or more temperature sensors 80, and/or other physiological, environment, biometric, or biological sensors. Further examples of physiological or biological sensors include one or more of an alcohol sensor 83, glucose sensor 85, or bilirubin sensor 87. Other examples of physiological or biological sensors may also be included in the. These may include, but are not limited to, a blood pressure sensor 82, an electroencephalogram (EEG) 84, an Adenosine Triphosphate (ATP) sensor, a lactic acid sensor 88, a hemoglobin sensor 90, a hematocrit sensor 92 or other biological or chemical sensor. The wireless earpiece 12 may also include any number of other sensors, including, but not limited to, device including, but not limited to, radiation sensors, altimeters, barometers, humidity sensors, impact sensors, skin conductivity, GPS, velocity sensors, and so forth.

A spectrometer 16 utilized for measuring and recording spectra is also shown. The spectrometer 16 may measure optical signals, infrared (IR), ultraviolet (UV), and so forth although it is contemplated that any number of wavelengths in the infrared, visible, or ultraviolet spectrums may be detected (even including radio, microwave, X-ray, and gamma ray). The spectrometer 16 may be adapted to measure and analyze environmental wavelengths for processing and recommendations and may correspondingly be located on or at the external facing side of the wireless earpiece 12.

A gesture control interface 36 is also operatively connected to or integrated into the intelligent control system 30. The gesture control interface 36 may include one or more emitters 82 and one or more detectors 84 for sensing user gestures. The emitters 82 may be of any number of types or utilize any number of signals, standards, or protocols including infrared LEDs. The detectors 84 may detect reflected light or signals to determine a gesture performed by a user of the wireless earpiece 12.

The wireless earpiece 12 may include any number of transceivers 34, 35, 37. The transceivers 34, 35, 37 are components including both a transmitter and receiver which may be combined and share common circuitry, chip, on a single housing. The wireless earpiece 12 may include a transceiver 35 which may allow for induction transmissions, such as through near field magnetic induction. A transceiver 34 may use Bluetooth, Wi-Fi, 3G, 4G, 5G, PCS, WiMAX, BLE, UWB, or other radio communication signals, protocols, formats, or standards. In operation, the intelligent control system 30 may be configured to convey different information using one or more of the LEDs 20 based on context or mode of operation of the device. The LEDs 20 are semiconductor based light sources. The LEDs 20 may also include displays, touch sensors, or other interface components. The LEDs 20 may be configured to provide information concerning the wireless earpieces 12. For example, the intelligent control system 30 may communicate a signal encoding information related to the current time, the battery life of the earpiece, the status of another operation of the earpiece, or another earpiece function, wherein the signal is decoded and displayed by the LEDs 20. Utilization information associated with the wireless earpiece 12 may also be communicated utilizing the LEDs. In one embodiment, the LEDs 20 may include one or more miniature screens or displays integrated into the wireless earpiece 12.

The various sensors 32, the processor 30, and other electronic components may be located on the printed circuit board of the wireless earpiece 12. One or more speakers 73 may also be operatively connected to the intelligent control system 30. Although not shown, the one or more speakers 73 of the wireless earpieces 12 may include a number of speaker components (e.g., signal generators, amplifiers, drivers, and other circuitry) configured to generate sounds waves at distinct frequency ranges (e.g., bass, woofer, tweeter, midrange, etc.) or to vibrate at specified frequencies to be perceived by the user as sound waves. The speakers 73 may also generate sound waves to provide three-dimensional stereo sound to the user.

A transceiver 37 may represent a magnetic induction electric conduction electromagnetic (E/M) field transceiver or other type of electromagnetic field receiver that may also be operatively connected to the intelligent control system 30 to link the processor 30 to the electromagnetic field of the user. The use of the E/M transceiver 37 allows the device to link electromagnetically into a personal area network, body area network or other device.

One or more processors within the intelligent control system 30 may be disposed, mounted, or integrated within the earpiece housings and operatively connected to the components of the respective wireless earpieces 12. In one embodiment, the processor includes circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks.

The processor may be configured to process information received from the various components. The processors may execute any number of operating systems, kernels, applications, or instructions. For example, processors may execute a program stored in a memory 31 related to explaining the fit, configuration, and utilization of the wireless earpieces 12. For example, the information may be provided to the user utilizing the LEDs 20 or the speakers 73.

The memory 31 is one or more hardware elements, devices, or recording media configured to store data for subsequent retrieval or access at a later time. The memory 31 may be or include static and/or dynamic memory. The memory 31 may include one or more of a hard disk, random access memory, cache, removable media drive, mass storage, or configuration suitable as storage for data, instructions, and information. In one embodiment, the memory 31 and the intelligent control system 30 may be integrated. The memory 31 may use any type of volatile or non-volatile storage techniques and mediums. The memory 31 may store information related to the status of a user, wireless earpieces 12, and other peripherals, such as a wireless device, smart case for the wireless earpieces 12, smart watch, and so forth. In one embodiment, the memory 31 may display instructions or programs for controlling a user interface which may include the one or more LEDs 20, speakers 73, tactile generators (e.g., vibrator), and so forth. The memory 31 may also store the user input information associated with each command. The memory 31 may store user preferences including parameters, settings, factors, user information, and so forth that may be utilized to implement automatic or manual processes as are herein described.

Although a number of different components are shown in FIG. 3, it is to be understood that the wireless earpiece 12 need not include all of the various components and may only include a subset of the components. For example, in one embodiment the wireless earpieces 12 may only serve as a set of wireless earpieces without microphones, without physiological sensors, and need not include storage. It is to be further understood that where there is a set of wireless earpieces some of the components may be present only in one of the wireless earpieces within the set. For example, not all sensors 32 need be present in each wireless earpiece 12.

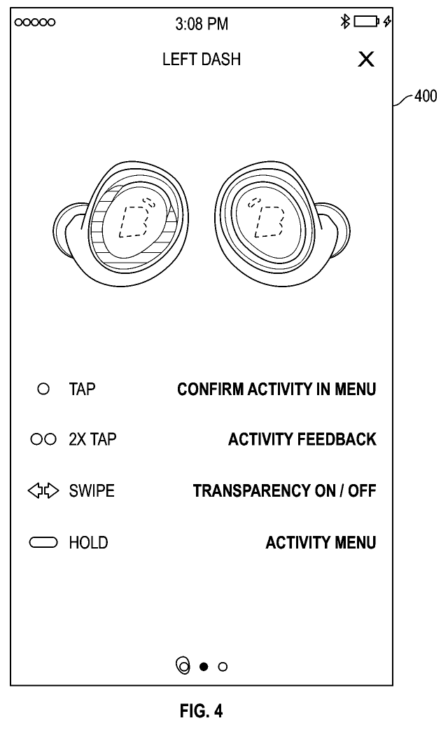

FIG. 4 illustrates one example of a display 400 associated with a software application or mobile app executing on a processor of a mobile device. The display 400 illustrates both a left wireless earpiece and a right wireless earpiece. The display 400 may include a caption or label indicating the “left” wireless earpiece. In addition, portions of the left wireless earpiece are illuminated using one or more LEDs. This portion of the wireless earpiece may be called a corona. Thus, a user using the mobile app may quickly and easily make the association between the left wireless earpiece which they are wearing and what is shown on the display 400. In one embodiment, under the representation of the wireless earpieces, which may be a photo, illustration, icon, or photo-realistic representation of the wireless earpieces, is information relating to the gestures, controls, user input and associated actions that may be implemented utilizing the wireless earpiece.

In one embodiment, textual descriptions of the commands are shown at the right of the display 400 and a pictorial representation or symbol or icon or graphic associated with the gesture is shown at the left of the display 400. Thus, here, a single dot may be shown which is intended to correspond with a single tap or “TAP.” The function associated with this user control, in this instance “CONFIRM ACTIVITY IN MENU” is shown. Next, two dots are shown which intended to correspond with a double tap or “2× TAP.’ The function associated with this user control, in this instance, “ACTIVITY FEEDBACK” is shown. Next, a left pointing arrow adjacent a right point arrow is shown. This visual representation is intended to correspond with a swipe or “SWIPE.” The function associated with this user input, in this instance, “TRANSPARENCY ON/OFF” is shown. Next, an ellipse or oblong shape is shown. This visual representation is intended to correspond with a hold or “HOLD.” The function associated with this user input, in this instance “ACTIVITY MENU” is shown. Thus, the display 400 of FIG. 4 illustrates that a user may perform various actions through manipulation of the left wireless earpiece using a set of gestures which may include a single tap, a double tap, a swipe, and/or a hold.

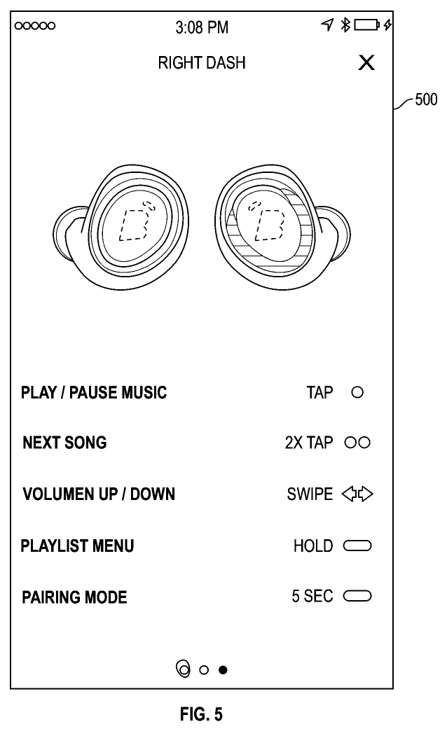

FIG. 5 illustrates another example of a display 500 associated with a software application or mobile app executing on a processor of a mobile device. The display 500 illustrates both a left wireless earpiece and a right wireless earpiece. The display 500 includes a caption or label indicating the “right” wireless earpiece. In additions, portions of the right wireless earpiece are illuminated using one or more LEDs. As previously noted, this portion of the wireless earpiece may be called a corona. Thus, a user using the mobile app may quickly and easily make the association between the right wireless earpiece which the user may be wearing and what is shown on the display 500. Under the representation of the wireless earpieces is information relating to the gestures, controls, user input, and associated actions that may be implemented by the wireless earpiece.

In one embodiment, textual descriptions of the commands are shown at the left and a pictorial representation or symbol or icon or graphic associated with the gesture is shown at the right. Thus, here a single dot is shown which is intended to correspond with a single tap or “TAP.” The function associated with this user control, in this instance “PLAY/PAUSE MUSIC” is shown. Next, two dots are shown which intended to correspond with a double tap or “2× TAP.’ The function associated with this user control, in this instance, “NEXT SONG” is shown. Next, a left pointing arrow adjacent a right point arrow is shown. This visual representation is intended to correspond with a swipe or “SWIPE.” The function associated with this user input, in this instance, “VOLUME UP/DOWN” is shown. Next, an ellipse or oblong shape is shown. This visual representation is intended to correspond with a hold or “HOLD.” The function associated with this user input, in this instance “PLAYLIST MENU” is shown. Thus, the display 500 of FIG. 5 illustrates that a user may perform various actions through manipulation of the right earpiece using a set of gestures which may include a single tap, a double tap, a swipe, and/or a hold.

As shown in FIG. 4 and FIG. 5, the same gestures may perform different actions depending upon whether the gesture is performed on the left wireless earpiece or the right wireless earpiece. It is contemplated, however, that different gestures may be used on different wireless earpieces and the same gestures may perform the same functions on different earpieces. In addition, instead of using the gesture control of the wireless earpieces to perform particular actions other types of user input may be used as well. This includes voice control or using the interface associated with the device executing the software application such as a touchscreen or manual inputs. In one embodiment, the user may utilize an application and associated user interface as shown by the displays 400 and 500 of FIGS. 4-5 to associated specified user actions for one of the wireless earpieces with a designated action or activity. For example, the user may be able to drag specified user input to be associated with user actions.

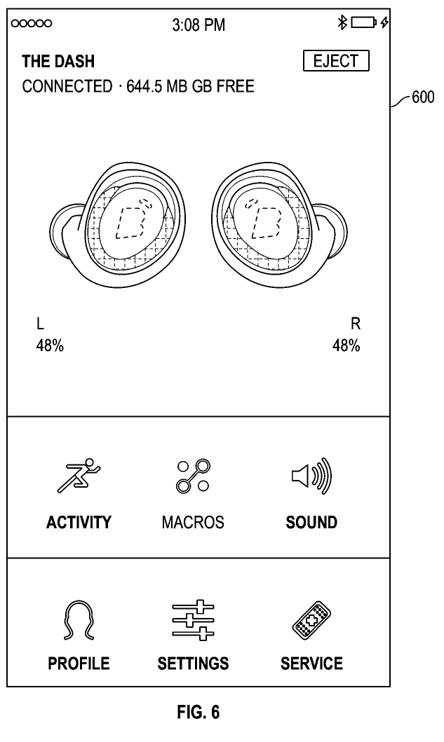

FIG. 6 illustrates another example of a display 600 associated with a software application or mobile app executing on a processor of a mobile device. In this display 600a left wireless earpiece and a right wireless earpiece are shown. Underneath the left wireless earpiece is an “L” indicating that this is the left earpiece. Underneath the “L” is textural information in the form of a numerical representation of remaining battery life for the left wireless earpiece, in this instance, “48%.” Underneath the right wireless earpiece is an “R” indicating that this is the right wireless earpiece. Underneath the “R” is textual information in the form of a numerical representation of remaining battery life for the right wireless earpiece, in this instance, “48%.” Although the battery charge level or remaining battery life is the same for both the left wireless earpiece and the right wireless earpiece in this example, it is to be understood that the left wireless earpiece and the right wireless earpiece may be different and that charge levels may be independently determined for each wireless earpiece.

Below the representations of the wireless earpieces is a menu which includes various functions associated with the wireless earpieces. These include an “ACTIVITY” menu item, a “MACROS” menu item, a “SOUND” menu item, a “PROFILE” menu item, a “SETTINGS” menu item, and a “SERVICE” menu item.

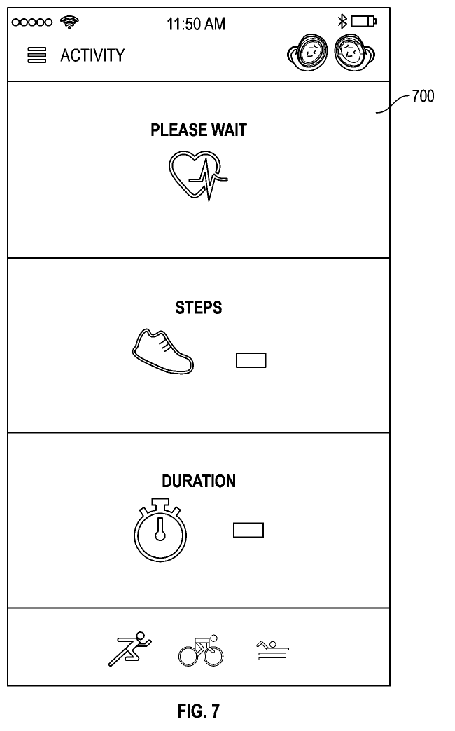

FIG. 7 illustrates another example of a display 700; in this instance the display 700 is for tracking activity. Various information associated with one or more activities may be displayed. On the bottom of the display 700 are three different icons or visual representations of different activities. The activities shown are running or jogging (left), biking (middle), and swimming (right). The selected activity as shown in FIG. 7 is running or jogging. Various information associated with this activity is also shown. This may include heart rate as measured by one or more of the wireless earpieces such as through use of a pulse oximeter, steps, as measured by one or more of the wireless earpieces such as through use of an inertial sensor, and duration. The display 700 may also be utilized to track cadence, distance travelled, user temperature, altitude, average speed, and any number of minimum, average, and maximum levels and other user, environmental, or mechanical metrics.

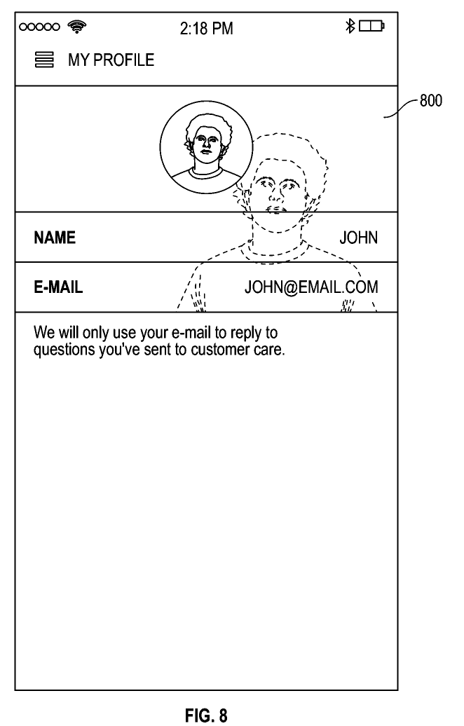

FIG. 8 illustrates another example of a display 800. In this instance the display is for displaying a “MY PROFILE” which may be used to include information about a user. For example, the information may include a name, email address, or other information. Other information may include age, height, weight, ethnicity, health status/condition, and other information that may be utilized to measure biometric information as well as provide the user alerts or alarms.

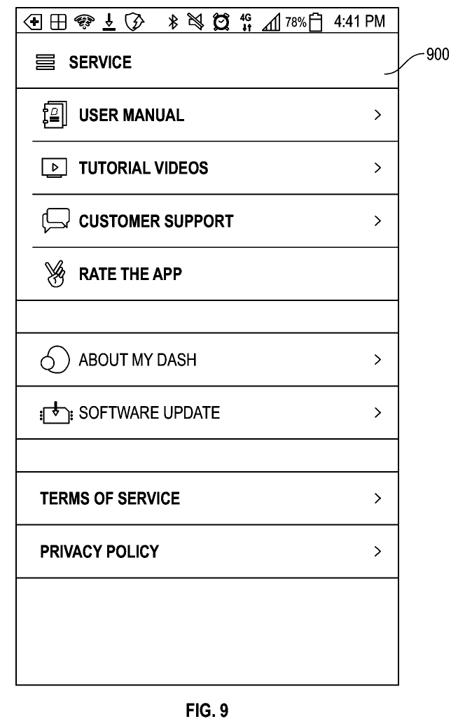

FIG. 9 illustrates another example of a display 900. In this embodiment, the display 900 is for displaying “SERVICE” information and various subsections, which may be manually selected by touching the desired tab or tapping the right arrow portion on the right side of the display 900. These subsections may include various options including the ability to view a “USER MANUAL,” view one or more “TUTORIAL VIDEOS,” which may provide a variety of instructional videos concerning the wireless earpiece, inquire about one or more technical issues via the “CUSTOMER SUPPORT” tab, rate the mobile app via the “RATE THE APP” tab, view the “TERMS OF SERVICE” or “PRIVACY POLICY” tabs, or, if the mobile device is in operative communication with one or more wireless earpieces, view information associated with the one or more wireless earpieces “ABOUT MY DASH” or get a “SOFTWARE UPDATE” from an outside source. The information shown in the display 900 (as well as the other referenced displays in the FIGS. 4-13) may be updated in real-time, based on a schedule, or periodically based on actions performed by a manufacturer, service provider, retailer, organization, business, or so forth.

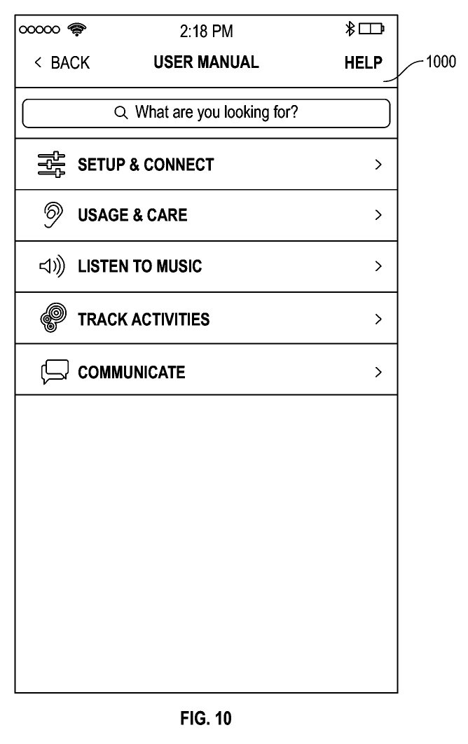

FIG. 10 illustrates another example of a display 1000. In this embodiment, the screen 1000 may be utilized to display the “USER'S MANUAL” which may be organized in various ways including a “SETUP & CONNECT” portion, a “USAGE & CARE” portion, a “LISTEN TO MUSIC” portion, a “TRACK ACTIVITIES” portion, and a “COMMUNICATE” portion. The content of the various displays of FIGS. 4-13 may be communicated through an application of a wireless device, such as a cell phone. The displays may also be communicated audibly through the wireless earpieces or a smart case associated with the wireless earpieces. In another embodiment, the content may be communicated through one or more linked devices, such as wireless devices, computing devices, speakers, or so forth.

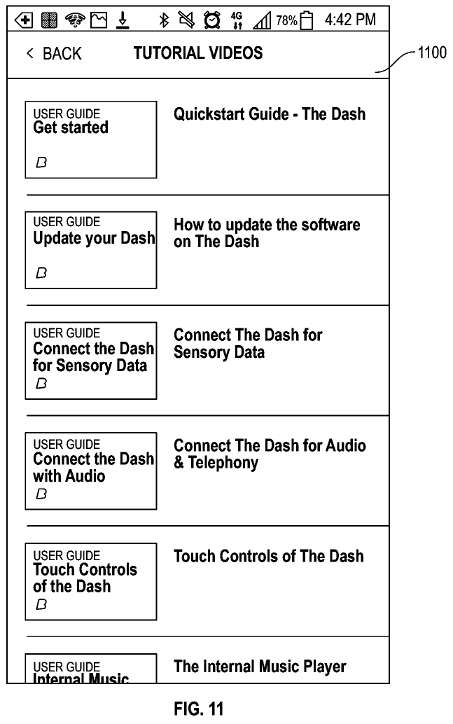

FIG. 11 illustrates another example of a display 1100. In one embodiment, the 1100 display is for displaying instructional videos under the “TUTORIAL VIDEOS” tab, with various videos related to how to use various functions of the wireless earpieces that may be named “The Dash.” The tutorial videos may include a Quickstart Guide video, a video concerning how to update software on the Dash, a video on how to connect the Dash for sensory data, a video on how to connect the Dash for audio and telephony, and a video concerning the touch controls of the Dash.

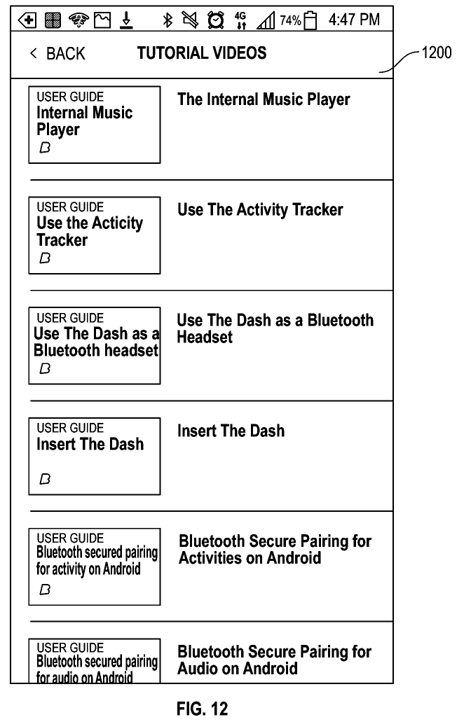

FIG. 12 illustrates another example of a display 1200. In one embodiment, the display 1200 shows the next five videos after the four shown in FIG. 11 under the “TUTORIAL VIDEOS” tab. The additional tutorial videos may include a video concerning the internal music player, a video concerning the use of the activity tracker, a video concerning how to use the Dash as a Bluetooth headset, a video concerning how to insert the dash, a video concerning how to use Bluetooth secure pairing for activities on Android, and a video concerning how to use Bluetooth secure pairing for audio on Android are shown.

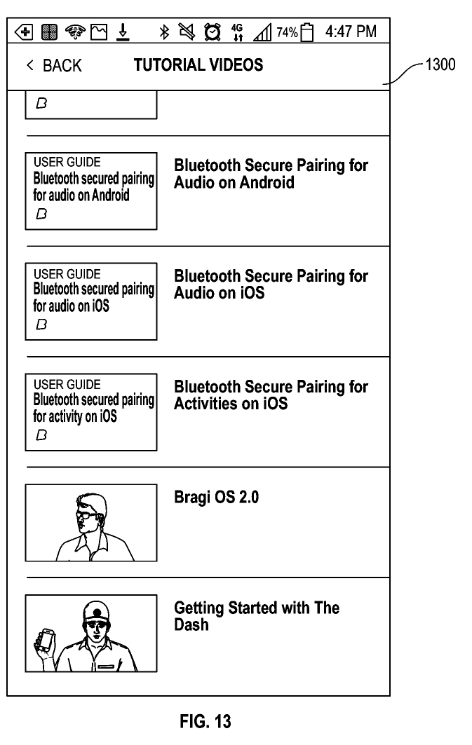

FIG. 13 illustrates another example of a display 1300. In one embodiment, the display 1300 shows the last five videos under the “TUTORIAL VIDEOS” tab. The additional tutorial videos may include a video concerning secure Bluetooth pairing for audio on Android, a video concerning secure Bluetooth pairing for audio on iOS, a video concerning secure Bluetooth pairing for Activities on iOS, a video concerning operating system updates, and a video on how to get started with the Dash are shown.

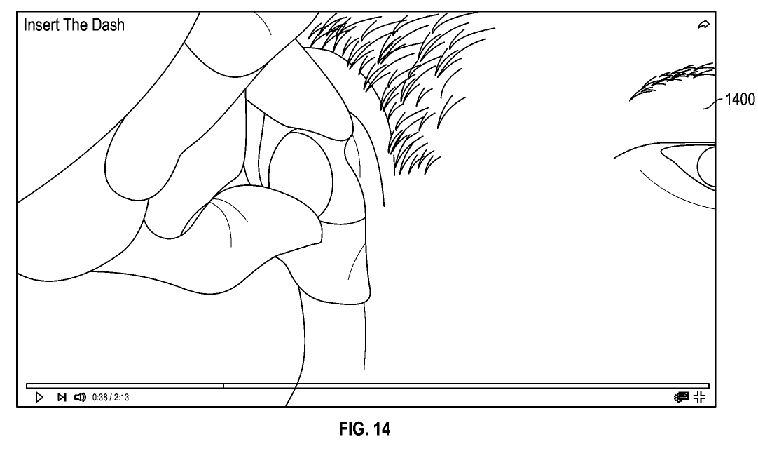

FIG. 14 shows a screenshot of a video 1400 concerning how to insert the wireless earpieces/Dash into a user's ear. The video 1400 may provide instruction concerning how to place a wireless earpiece into a user's ear, how to optimize the placement of a wireless earpiece, incorrect positions of a wireless earpiece in a user's ear, or how to fix the placement of a wireless earpiece that is already placed in a user's ear. The video 1400 may also be hosted on a third-party site. The video 1400 may be controlled, shared, or otherwise managed utilizing any number of standard controls or sharing features.

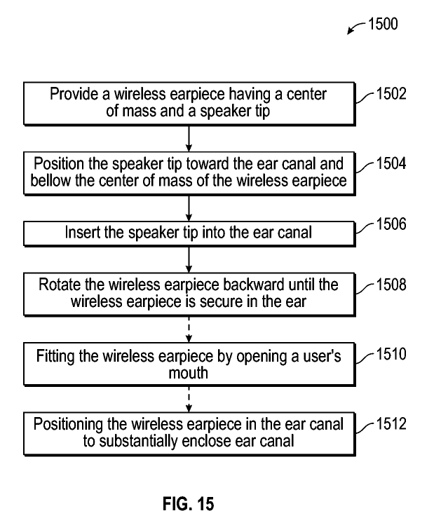

FIG. 15 illustrates a flowchart of a method of installing a wireless earpiece into an ear canal of an ear 1500. The process of FIG. 15 may be communicated to the user through an application, website, the wireless earpieces themselves, a smart case of the wireless earpieces, a wireless device communication with the wireless earpieces, or so forth. Although the wireless earpieces are shown utilizing an in-ear method of being worn, the wireless earpieces may also represent over hear headphones similar to existing headphones with the features, components, and functionality here described. First, in step 1502, a wireless earpiece having a center of mass and a speaker tip is provided. A left wireless earpiece and a right wireless earpiece may be provided. The speaker tip may be positioned at any location on the back of the wireless earpiece, and in some embodiments, the speaker tip may be positioned near a corner or outer edge of the back of the wireless earpiece.

In step 1504, the wireless earpiece is positioned proximate to the ear such that the speaker tip is positioned both toward the ear canal and below the center of mass of the wireless earpiece. The positioning of the speaker tip below the center of mass is to improve the efficacy of improving the fit of the speaker tip into the ear canal once the wireless earpiece is placed into the ear.

In step 1506, the speaker tip is inserted into the ear canal. The insertion may be partial or substantially complete depending on how the user fits the wireless earpiece to their ear and the dimensions of the user's ear relative to the size of the wireless earpiece.

In step 1508, the wireless earpiece is rotated backward in order to substantially secure the wireless earpiece in the ear. It is possible that no rotation may be required depending on how the positioning of the wireless earpiece and the dimensions of the user's ear when the speaker tip is inserted, and substantially secure may mean that the wireless earpiece will not fall out of the ear when released by the user after insertion. Additionally, if the wireless earpiece is dislodged, loses its fit for whatever reason, becomes less than substantially secure, or becomes uncomfortable in the ear canal, in step 110, the user may open his mouth to fit the wireless earpiece to the ear. The user may perform this step at any time for any reason if the user desires a better fit.

In addition, in step 112, if the user is hearing unwanted external sounds, the user may manually position the wireless earpiece to substantially enclose the ear canal. The substantially enclosing of the ear canal may improve audio transparency of sounds communicated by the wireless earpiece.

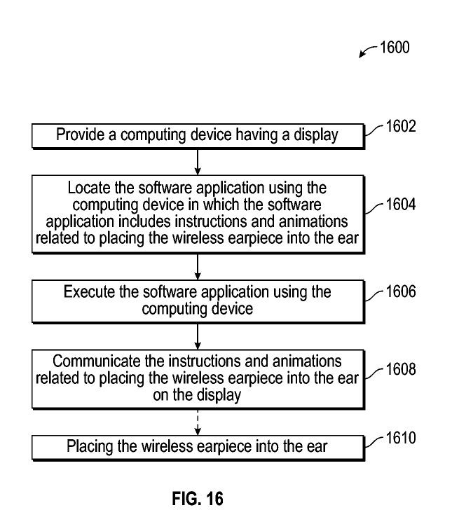

FIG. 16 illustrates a flowchart of a method of instructing a user as to how to place a wireless earpiece into an ear using a software application 1600. First, in step 1602, a computing device having a display is provided. The computing device may be a mobile device such as a smartphone, a tablet, a laptop, a desktop computer, or any other type of device with computing capability having a display. In another embodiment, the computing device may be the wireless earpieces themselves (e.g., utilizing a miniature screen, enhanced audio output of the speakers, the smart case of the wireless earpieces, etc.).

In step 1604, the software application is located using the computing device in which the software application includes instructions and animations related to placing the wireless earpiece into the ear. The locating may be performed by a user or a third party using an interface on the computing device, the wireless earpieces/wireless headset, a digital interface programmed within the software application itself, a third-party software program installed on the computing device, a third-party software program installed on a third-party device in operative communication with the computing device, or a combination thereof. In addition, the software application may include a mobile app, and the instructions and animations related to placing the earpiece into the ear may further include instructions for a left wireless earpiece and a right wireless earpiece into a left ear and a right ear, correspondingly.

In step 1606, the software application is executed on the computing device. The execution may be performed immediately after the location of the software application or may be performed at a time after location, and the time may be substantial.

In step 1608, the instructions and animations related to placing the wireless earpiece into the ear on the display are communicated. The instructions and animations related to placing the earpiece into the ear may be communicated to the user, a third party, or a combination thereof, and the display may have a user interface allowing the user or third party to interact with the instructions and animations related to placing the wireless earpiece into the ear, which may be formatted into one or more screens to allow the user or third party to scroll through in order to improve ease of use. Optionally, in step 1610, the user may place the earpiece into their ear. The fit of the earpiece may not be substantially secure and may not properly fit the contours of the user's ear.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

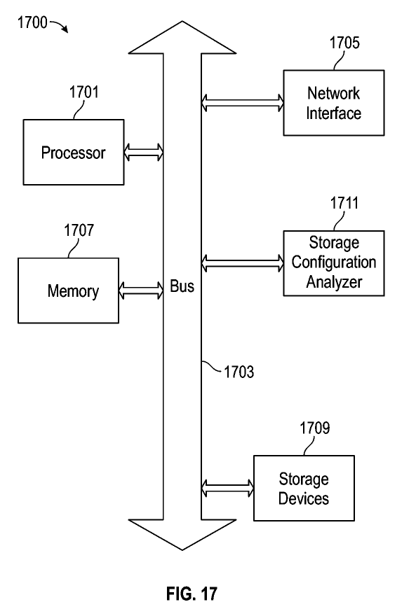

FIG. 17 depicts a computing system 1700 in accordance with an illustrative embodiment. For example, the computing system 1700 may represent a device, such as the wireless device 204 of FIG. 2. The computing system 1700 includes a processor unit 1701 (possibly including multiple processors, multiple cores, multiple nodes, and/or implementing multi-threading, etc.). The computing system includes memory 1707. The memory 1707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 1703 (e.g., PCI, ISA, PCI-Express, HyperTransport®, InfiniBand®, NuBus, etc.), a network interface 1706 (e.g., an ATM interface, an Ethernet interface, a Frame Relay interface, SONET interface, wireless interface, etc.), and a storage device(s) 1709 (e.g., optical storage, magnetic storage, etc.). The system memory 1707 embodies functionality to implement all or portions of the embodiments described above. The system memory 1707 may include one or more applications or sets of instructions for implementing a communications engine to communicate with one or more wireless earpieces and/or electronic devices. The software, applications, or instructions herein described may be stored in the system memory 1707 and executed by the processor unit 1702. Code may be implemented in any of the other devices of the computing system 1700. Any one of these functionalities may be partially (or entirely) implemented in hardware and/or on the processing unit 1701. For example, the functionality may be implemented with an application specific integrated circuit, in logic implemented in the processing unit 1701, in a co-processor on a peripheral device or card, etc. Further, realizations may include fewer or additional components not illustrated in FIG. 17 (e.g., video cards, audio cards, additional network interfaces, peripheral devices, etc.). The processor unit 1701, the storage device(s) 1709, and the network interface 1705 are coupled to the bus 1703. Although illustrated as being coupled to the bus 1703, the memory 1707 may be coupled to the processor unit 1701. The computing system 1700 may further include any number of optical sensors, accelerometers, magnetometers, microphones, gyroscopes, temperature sensors, and so forth for verifying user biometrics, or environmental conditions, such as motion, light, or other events that may be associated with the wireless earpieces or their environment.

The features, steps, and components of the illustrative embodiments may be combined in any number of ways and are not limited specifically to those described. The illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method of installing a wireless earpiece into an ear canal of an ear comprising:
providing the wireless earpiece having a center of mass and comprising a speaker tip;
positioning the speaker tip proximate to the ear, toward the ear canal and below the center of mass of the wireless earpiece;
inserting the speaker tip into the ear canal; and
rotating the wireless earpiece backward until the wireless earpiece is substantially secure in the ear.

2. The method of claim 1 wherein the wireless earpiece comprises a left wireless earpiece and a right wireless earpiece.

3. The method of claim 2 wherein the ear canal of the ear comprises a left ear canal of a left ear and a right ear canal of a right ear.

4. The method of claim 1 further comprising fitting the wireless earpiece by opening a user's mouth.

5. The method of claim 3 further comprising positioning each wireless earpiece in each ear canal to substantially enclose each ear canal.

6. A method of instructing a user as to how to place an earpiece into an ear using a software application comprising:
providing a computing device having a screen display element;
locating the software application using the computing device, wherein the software application comprises instructions and animations related to placing the earpiece into the ear;
executing the software application using the computing device; and
communicating the instructions and animations related to placing the earpiece into the ear on the screen display element.

7. The method of claim 6 further comprising placing the earpiece into the ear.

8. The method of claim 7 wherein the placement is performed by the user.

9. The method of claim 7 wherein the earpiece comprises a left earpiece and a right earpiece.

10. The method of claim 9 wherein the instructions and animations related to placing the earpiece into the ear further comprise instructions and animations related to placing the left earpiece into a left ear and placing the right earpiece into a right ear.

11. The method of claim 6 wherein the computing device further comprises a first user interface.

12. The method of claim 11 wherein the locating of the software application is performed using the first user interface.

13. The method of claim 11 wherein the software application further comprises a second user interface.

14. The method of claim 13 wherein the instructions and animations related to placing the earpiece into the ear are formatted into a plurality of interactive screens.

15. The method of claim 14 wherein the first user interface is used to scroll through the plurality of interactive screens.

16. The method of claim 14 wherein the second user interface is used to scroll through the plurality of interactive screens.

17. The method of claim 16 wherein the second user interface is used to interact with the plurality of interactive screens.

18. The method of claim 6 wherein the computing device is a mobile device having a screen display.

19. The method of claim 18 wherein the software application is a mobile app.

20. The method of claim 6, wherein one or more of the wireless earpiece, a smart case of the wireless earpiece, or a wireless device linked with the wireless earpiece communicate the instructions.
